(19) United States
(12) Patent Application Publication
(10) Pub. No.: US 2009/0239505 A1
(43) Pub. Date: Sep. 24, 2009

(54) Systems and methods for distributing messages to mobile devices

(76) Inventors: Thyagarajapuram S. Ramakrishnan, Saratoga, CA (US); David Barnes Still, JR., Menlo Park, CA (US); Chintamani Patwardhan, Saratoga, CA (US); Paul James Devine, San Francisco, CA (US); Ajav Arora, New York, NY (US); Ankit Nautiyal, Singapore (SG); Sumesh Menon, Singapore (SG)

Correspondence Address: CARR & FERRELL LLP, 2200 GENG ROAD, PALO ALTO, CA, 94303, US

(21) Appl. No.: 12/380,224

(22) Filed: Feb. 24, 2009

Related U.S. Application Data
(63) Continuation-in-part of application No. 12/012,094, filed on Jan. 30, 2008.
(60) Provisional application No. 60/898,678, filed on Jan. 30, 2007.

(51) Int. Cl. H04M 11/10; H04W 4/12

(52) U.S. Cl. 455/413; 455/466

(57) ABSTRACT

A system and method for delivering messages and/or multimedia content using a short message services (SMS) telecommunication network. Mobile devices are coupled to the telecommunication network. A sender may distribute the message using a mobile device to a recipient on another telecommunication network. In one embodiment, a message is requested using a unique pairing identifier and the message is streamed to the recipient. The message may include a multimedia content, and may be based on a demographic trait of the recipient.

### CROSS-REFERENCE TO RELATED APPLICATIONS

This continuation-in-part application claims the benefit and priority of U.S. application Ser. No. 12/012,094 titled “Systems and Methods for Distributing Messages to Mobile Devices,” filed Jan. 30, 2008, which in turn claims the benefit and priority of U.S. Provisional Application Ser. No. 60/898,678 titled “Systems and Methods for Voice Messaging,” filed Jan. 30, 2007, each of which is hereby incorporated by reference.

### BACKGROUND

1. Field of Invention

The present invention relates generally to messaging, and more particularly to systems and methods for distributing messages to mobile devices.

2. Related Art

The popularity of mobile communications has expanded the available protocols beyond voice communications to text messaging, such as Short Message Service (SMS), and voice messaging, such as Short Voice Message Service (SVMS). SMS is a telecommunication service allowing mobile device users to send and receive text messages. SVMS allows mobile device users to send and receive voice recordings.

Traditionally, SMS users subscribe to a cellular telephone provider. SMS senders typically include many abbreviations to keep a message short. SMS thus provides a “type and read” text messaging service to mobile devices. SMS and SVMS lack a guarantee that a message will be delivered to a recipient, and lack a confirmation that a message was delivered.

### SUMMARY

Embodiments of the invention include a method for receiving a message from a sender intended for a recipient, the message received using a server, assigning a unique pairing identifier for use by the recipient, and sending a notice to the recipient, the notice including the unique pairing identifier. The method further includes receiving a request from the recipient requesting the message, the request including the unique pairing identifier, and streaming the message to the recipient using the server.

According to another embodiment of the invention, a method includes receiving a message intended for a recipient using a server, storing the message on the server, associating a message identifier with the message, the message identifier configured to distinguish the message from other messages intended for the recipient, and sending the message identifier to the recipient. The method further includes streaming the message to the recipient each time the recipient requests the message, the request including the message identifier.

According to another embodiment of the invention, a computer readable medium has embodied thereon a program, the program being executable by a computing device for performing a method comprising receiving a message from a sender intended for a recipient, the message received using the computing device, assigning a unique pairing identifier for use by the recipient and sending a notice to the recipient, the notice including the unique pairing identifier. The method further includes receiving a request from the recipient requesting the message, the request including the unique pairing identifier, and streaming the message to the recipient using the computing device.

### BRIEF DESCRIPTION OF THE DRAWINGS

Elements in the figures are illustrated for simplicity and clarity and are not drawn to scale. The dimensions of some of the elements may be exaggerated relative to other elements to help improve the understanding of various embodiments of the invention.

FIG. 1 is a block diagram illustrating an exemplary system for distributing messages to mobile devices.

FIG. 2 is a flow chart illustrating an exemplary method for distributing messages to mobile devices.

FIG. 3 is a flow chart illustrating an exemplary method for using sound icons.

FIG. 4 is a flow chart illustrating an exemplary method for distributing messages to mobile devices.

FIG. 5 is a diagram illustrating unique pairing identifiers.

FIG. 6 is a block diagram of a bubble server in one exemplary implementation of the invention.

FIG. 7 is a flow chart showing an exemplary method for distributing a voice message to a first mobile device wherein a telecommunication network diverts a connection from a second mobile device to a bubble server.

FIG. 8 is a partial block diagram of a system in an exemplary implementation for distributing a voice message to a first mobile device wherein a telecommunication network diverts a connection from a second mobile device to the system.

### DETAILED DESCRIPTION

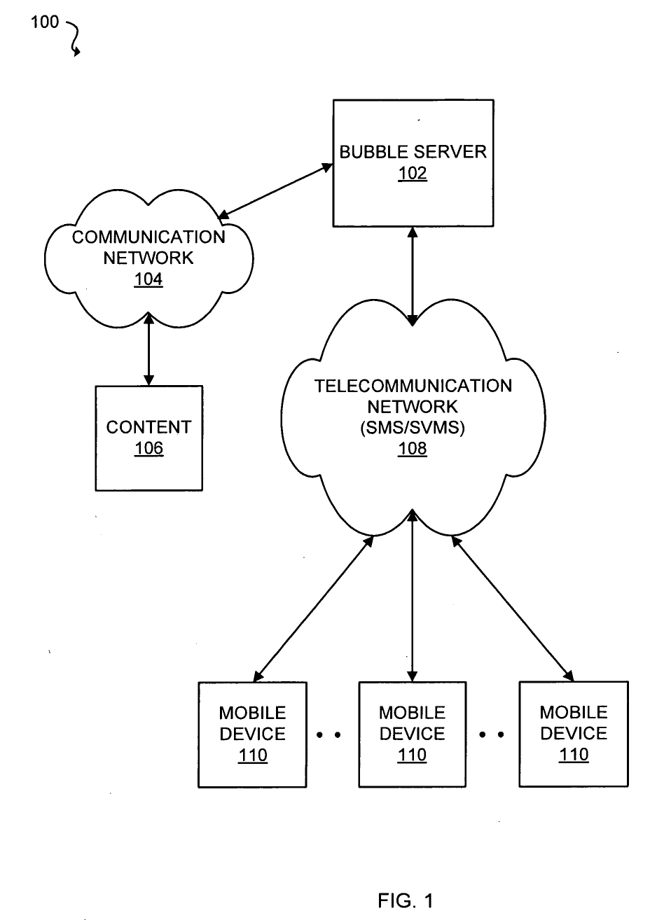

FIG. 1 is a block diagram illustrating an exemplary system 100 for distributing messages to mobile devices. System 100 comprises a bubble server 102, a communication network 104, a content 106, a telecommunication network (SMS/SVMS) 108, and the mobile devices 110. Using a SMS/SVMS service capability provided by the telecommunication network (SMS/SVMS) 108, the bubble server 102 facilitates the distribution of messages to the mobile devices 110.

In various embodiments, system 100 may be one of a plurality of similar systems coupled via the communication network 104 and/or the telecommunication network (SMS/SVMS) 108. Thus, a sender (not shown) may distribute a message using a mobile device 110 to a recipient (not shown) coupled to a second telecommunication network (SMS/SVMS) (not shown).

The bubble server 102, according to one embodiment, may be a computing device configured to store and process instructions, store and process data, and communicate with the communication network 104, the content 106, the telecommunication network (SMS/SVMS) 108, and the mobile devices 110. The bubble server 102 receives a message from a sender intended for a recipient, and assigns a unique pairing identifier for use by the recipient. The bubble server 102 further sends a notice to the recipient, the notice including the unique pairing identifier, receives a request from the recipient requesting the message, the request including the unique pairing identifier, and streams the message to the recipient. The bubble server 102 thus provides a click, talk and send capability that is not provided by the “type and read” messaging services provided by a Short Message Service (SMS) system. Streaming includes data streaming, audio streaming and video streaming, and includes providing to mobile device 110 the message such that the recipient may listen to and/or view the message while the message is being streamed.

The bubble server 102 may communicate with the communication network 104, the content 106, the telecommunication network (SMS/SVMS) 108, and the mobile devices 110 using appropriate protocols, such as the Hypertext Transfer Protocol (HTTP), File Transfer Protocol (FTP), short message service (SMS), short voice message service (SVMS), cellular telephone protocols such as Global System for Mobile communications (GSM), Code Division Multiple Access (CDMA), General Packet Radio Service (GPRS), Enhanced Data Rates for GSM Evolution (EDGE), or High-Speed Circuit-Switched Data (HSCSD), and/or other standards for communicating with digital devices, such as, but not limited to, Institute of Electrical and Electronics Engineers (IEEE) Standards 802.11 a/b/g/n, Bluetooth, and so forth.

The communication network 104 couples the content 106 to the mobile devices 110 via the bubble server 102 and the telecommunication network (SMS/SVMS) 108. The content 106 may be accessed by several methods, including, but not limited to the web or telephone devices. The content 106 may be one or more forms of messages, information, and/or data. The content 106 may include a SMS and/or SVMS message, multimedia content, including, but not limited to, audio content (e.g., voice messages), music, electronic books, video content, animation content, and/or other forms of content for communication, advertising, entertainment, and so forth.

The mobile devices 110 may access the content 106 to listen and/or view a multimedia content, to dedicate a multimedia content to a recipient, and/or to forward a multimedia content to a recipient. A user of the mobile devices 110 may access the content 106 using a subscription model, or may purchase the content 106, such as a ringtone, voice message, music, and so forth. The bubble server 102 may include the content 106, and/or the content 106 may be coupled to the bubble server 102 as illustrated in FIG. 1.

The content 106 may include famous quotes or statements from prominent celebrities, such as a voice message saying, ‘Frankly, my dear, I don't give a damn,’ or ‘Make my day.’ The content 106 may be in the sender's voice, or may be in the voice of another person. Other messages may include a song, such as the ‘happy birthday’ song, or other theme song, with background music and the sender's voice, or with someone else's voice singing the words. In various embodiments, the content 106 may include a cross-network talk and listen message of the BubbleTalk™ system developed by Bubble Motion, Pte. Ltd. Access to the content 106 may be provided by the web, i.e., the Internet, via HTTP, FTP, and/or telephone services, including, but not limited to GSM, CDMA, GPRS, EDGE or HSCSD, and/or Bluetooth, and so forth.

The telecommunication network (SMS/SVMS) 108 provides SMS and SVMS services to the mobile devices 110, and couples the bubble server 102, the content 106, and the mobile devices 110. The telecommunication network (SMS/SVMS) 108 may be a cellular telephone network, such as GSM, CDMA, GPRS, EDGE, HSCSD, or other communication network for communicating with remote digital devices using, for example, IEEE Standards 802.11 a/b/g/n, Bluetooth, and so forth.

The mobile devices 110 provide access between senders and recipients (e.g., mobile device users), the bubble server 102 and the content 106. The mobile devices 110 may be a cellular telephone, a personal digital assistant, a laptop computer, or other portable digital device. The mobile devices 110 need not be mobile in the conventional sense, and may include any digital device configured to couple to the telecommunication network (SMS/SVMS) 108.

To access the content 106, a mobile device user may register their mobile device 110 using the communication network 104. After registration, the mobile device user has access to send and receive messages via the system 100. A mobile device user may call in and listen to the content 106, i.e., by pulling the content 106 to the user's mobile device 110. A mobile device user may access a content channel (e.g., a portion of the content 106) to listen to or view different types of content. A mobile device user may forward the content 106 to a friend, i.e., push the content 106 to a recipient. A mobile device user may call in and dedicate the content 106 to a friend, i.e., a recipient, who may then receive the content 106.

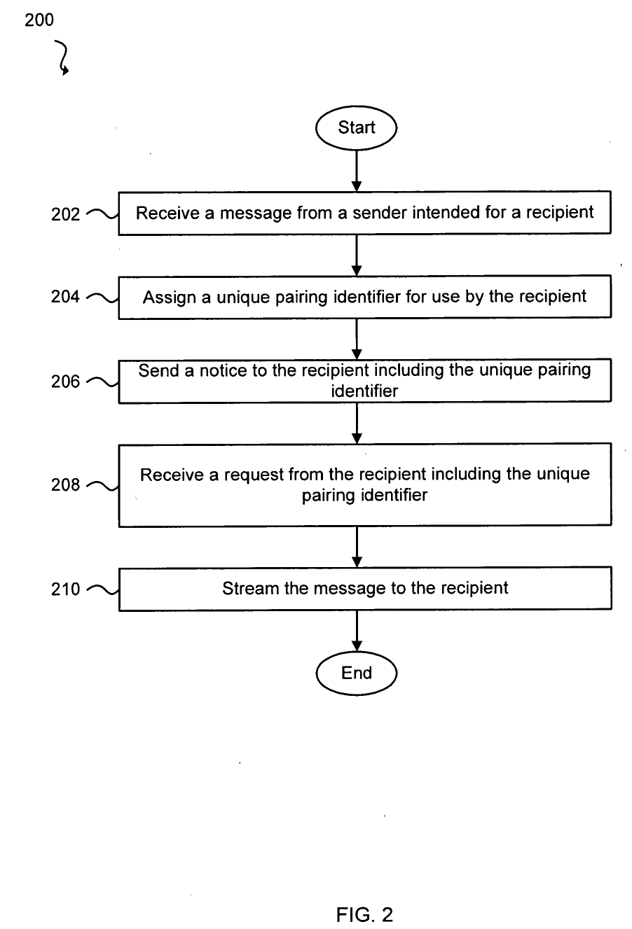

FIG. 2 is a flow chart illustrating an exemplary method 200 for distributing messages to mobile devices. At step 202, the bubble server 102 (FIG. 1) receives a message from a sender intended for a recipient. The message may be received using the telecommunication network (SMS/SVMS) 108, and the message may be a SMS or SVMS message. The sender may use the mobile device 110 (FIG. 1) to send the message. The sender may alternatively use other communication networks, e.g., the Internet, a telephone, and so forth, to send the message intended for a recipient.

At step 204, a unique pairing identifier is assigned for use by the recipient. The unique pairing identifier uniquely identifies the sender to the recipient, and allows the recipient to receive the sender's messages. The unique pairing identifier allows the bubble server 102 to receive a request from the recipient requesting the message. Thus, the recipient may not need the sender's telephone number to request the message. In one example, a unique pairing identifier may be an asterisk and a number 21, e.g., “*21.” The unique pairing identifier may be specific to the sender and the recipient, so that the recipient needs only to provide the unique pairing identifier to view any message from the sender. The unique pairing identifier may be created immediately from the first message, or the unique pairing identifier may be created after a sender sends a pre-determined number of messages to a recipient.

At step 206, a notice is sent to the recipient, the notice including the unique pairing identifier. The unique pairing identifier may be displayed on the recipient's mobile device 110 as an incoming notice. The notice informs the recipient that a message from the sender is available for streaming to the recipient. The notice may appear in an “inbox” of the recipient's mobile device 110. The notice may describe a multimedia content. Thus, the recipient may use the notice to determine whether to request the multimedia content.

At step 208, a request including the unique pairing identifier is received from the recipient. To send the request, the recipient may use the mobile device 110 to click, tap, and/or otherwise enter the unique pairing identifier. For later retrieval, or for retrieval of multiple messages from the same sender, the recipient may use the unique pairing identifier to view a list of messages from the same sender, and then select the specific message to be streamed to the recipient.

At step 210, the message is streamed to the recipient using bubble server 102. The message may be stored on bubble server 102. Using the unique pairing identifier, the recipient may repeat step 208 to request the message again.

A sender may create a notice describing a content 106 and send the notice to one or more recipients. In various embodiments, the content 106 may be streamed to the recipient on a subscription basis. Thus, the recipient may request the content 106 in advance of receiving the notice sent in step 206.

The bubble server 102 may optionally provide confirmations to the sender. At step 206, the bubble server 102 may provide a confirmation that a notice was sent to the recipient. At step 210, the bubble server 102 may provide a confirmation that the message was streamed to the recipient. The confirmation may include information describing how much of the message was streamed to the recipient. After a period of time, the bubble server 102 may send a confirmation to the sender that the recipient has not requested the message.

The sender may associate a multimedia content from content 106 with the message, and the multimedia content may be streamed to the recipient as described herein with respect to step 210. Furthermore, the multimedia content may be based on a demographic trait of the recipient, and/or may include advertising content.

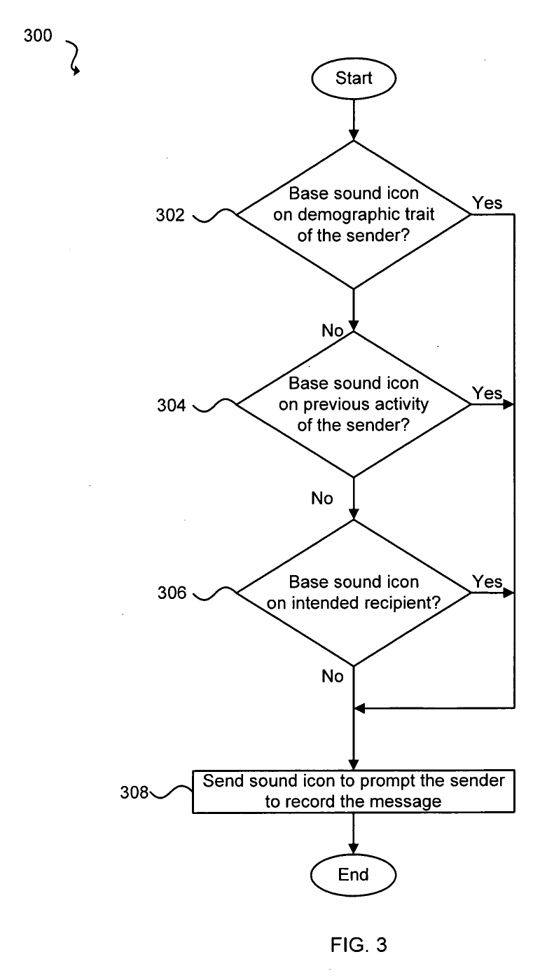

FIG. 3 is a flow chart illustrating an exemplary method 300 for using sound icons. A sound icon may be any sound that is provided by the bubble server 102 to mobile devices 110 for the purpose of aiding the senders in the use of the system 100 (FIG. 1). In one example, a sound icon may be a verbal, or a non-verbal sound that the bubble server 102 provides to a mobile device 110 to prompt a sender to record a message intended for a recipient.

In step 302, the sound icon may be based on a demographic trait of the sender, such as a female voice for a female sender, a sound in the language of the sender, and so forth.

In step 304, the sound icon may be based on the previous activity of the sender. A sender that is familiar with the use of the system 100 may be provided with sound icons that are shortened or otherwise modified. A sender with several experiences with the system 100 may have familiarity with the system 100, and may know expected responses without voice prompts. Thus, the length of the sound, or the type of sound used, could be based on the previous activity of the sender. For example, a sender with several experiences with the system 100 may use sound icons that shorten the amount of time needed to send messages.

In step 306, the sound icon may be based on the intended recipient. Thus, the sound icon that the sender hears may be selected by the intended recipient. For example, an intended recipient may select a particular sound icon when the sender is a family member and a different sound icon when the sender is a friend.

In step 308, the sound icon is sent to the sender to prompt the sender to record a message. For example, a “blub blub” sound icon may prompt a sender to record a message. Other examples of sound icons include a “dial tone” sound that may prompt a sender to enter a recipient's telephone number or unique pairing identifier. A “slash” sound icon may alert the sender that a message could be deleted, was about to be deleted, or had been deleted. A “beep-beep-beep” sound icon may alert a user at the end of the message, or to select the next activity.

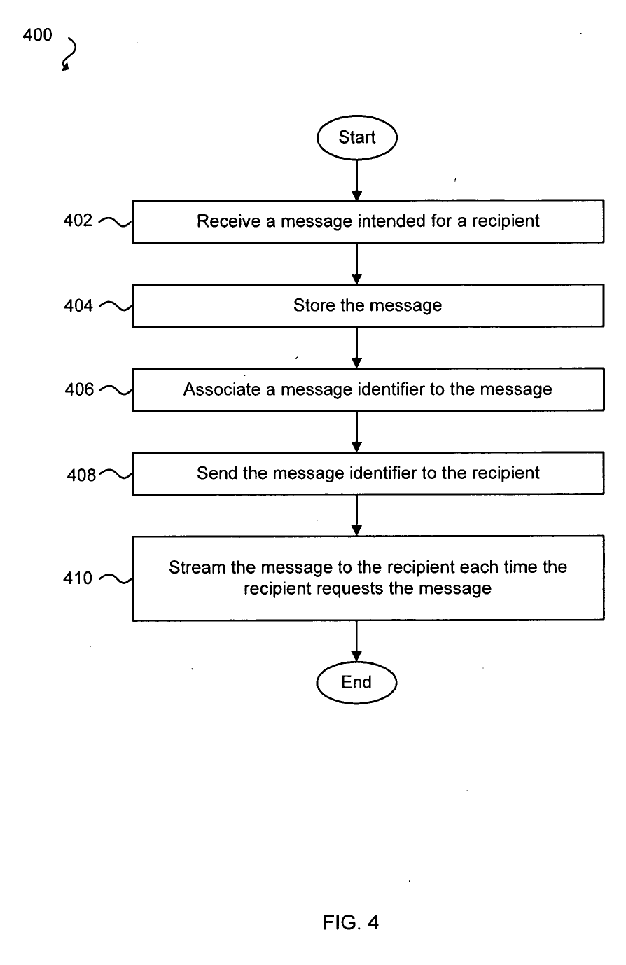

FIG. 4 is a flow chart illustrating an exemplary method 400 for distributing messages to mobile devices. At step 402, bubble server 102 (FIG. 1) receives a message from a sender intended for a recipient. The message may be received using the telecommunication network (SMS/SVMS) 108, and the message may be a SMS or SVMS message. The sender may use the mobile device 110 to send the message. The sender may alternatively use other communications networks, e.g., the internet, a telephone, and so forth to send the message intended for the recipient.

At step 404, the message is stored using the bubble server 102.

At step 406, a message identifier is associated with the message. The message identifier is not based on the sender, and may be configured to distinguish the message from other messages intended for the recipient. The association of the message identifier with the message allows the recipient to request and stream the message each time the recipient requests the message via the message identifier.

At step 408, the message identifier is sent to the recipient. The message identifier may be in the form of a notice.

At step 410, the message is streamed to the recipient each time the recipient requests the message.

The message may be a short message service, i.e., text message, for example a SMS message or a SVMS message. A multimedia content provided by the content 106 may be associated with the message. The multimedia content may include, but is not limited to, audio content, e.g. music, electronic books, and other forms of audio entertainment content, as well as video content, voice messages, animation content, or other forms of content for communication, advertising, entertainment, etc. The multimedia content may be streamed to the recipient each time the recipient requests the message. The multimedia content may be advertising content, based on a demographic trait of the recipient, or the like.

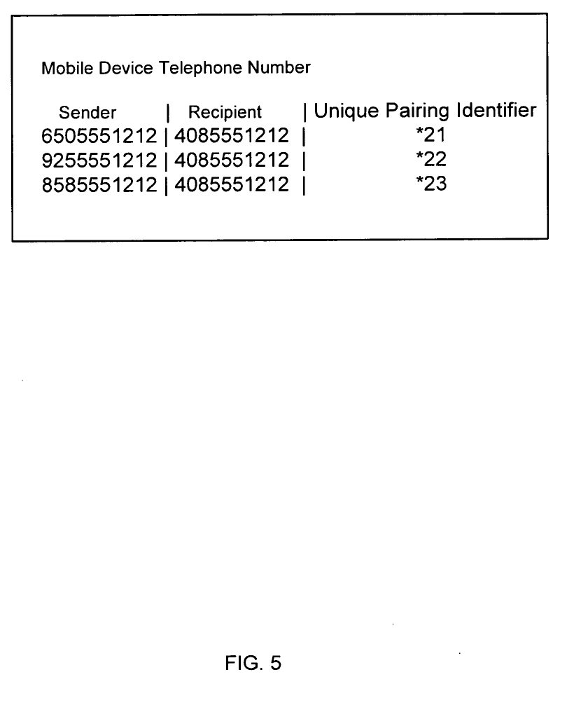

FIG. 5 is a diagram illustrating unique pairing identifiers. As shown in FIG. 5, a recipient has a unique pairing identifier for each sender.

For example, the recipient at mobile device 4085551212 has three senders.

The unique pairing identifier of sender 6505551212 for this recipient is *21.

The unique pairing identifier of sender 9255551212 for this recipient is *22.

The unique pairing identifier of sender 8585551212 for this recipient is *23.

Thus, the recipient at mobile device 4085551212 may request the messages of each of the senders above using the sender's unique pairing identifier instead of the sender's telephone number.

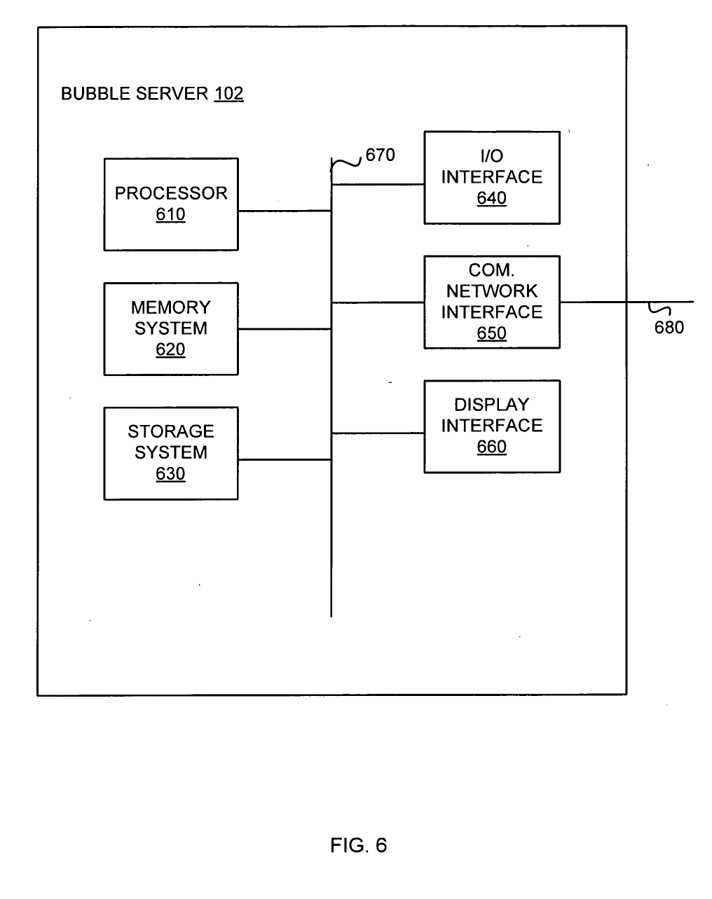

FIG. 6 is a block diagram of the bubble server 102 in one exemplary implementation of the invention. The bubble server 102 comprises a processor 610, a memory system 620, a storage system 630, an input/output (“I/O”) interface 640, a communication network interface 650, and a display interface 660 which may be coupled to a system bus 670. The processor 610 is configured to execute executable instructions. In some embodiments, the processor 610 comprises circuitry or any processor capable of processing the executable instructions.

The memory system 620 may be any memory configured to store data. Some examples of the memory 620 are storage devices, such as RAM or ROM. The storage system 630 may be any storage configured to retrieve and store data. Some examples of the storage system 630 are flash drives, hard drives, optical drives, and/or magnetic tape. The storage system 630 may comprise the content 106. In some embodiments, the bubble server 102 may include the memory system 620 in the form of RAM and the storage system 630 in the form of flash data.

The I/O interface 640 may be any device that can receive input for controlling and accessing the bubble server 102. The I/O interface 640 may couple to a keyboard, touchscreen, mouse, keypad, printer, scanner, or any other input or output device.

The communication network interface 650 may be coupled to the communication network 104 and the telecommunication network 108 (FIG. 1) via the link 680. FIG. 6 shows a single link 680 for simplicity. However, bubble server 102 may include more than one of the link 680. Moreover, the communication network interface 650 may support communication over many kinds of connections, including, but not limited to, a USB connection, a firewire connection, an Ethernet connection, a serial connection, a parallel connection, or an ATA connection. The communication network interface 650 may also support wireless communication (e.g., 802.11 a/b/g/n or wireless USB).

The display interface 660 is any device that may control a display device. A display device can be a monitor, screen, LCD, flatscreen, or any device configured to display information. The display device may be provided to control and access the bubble server 102.

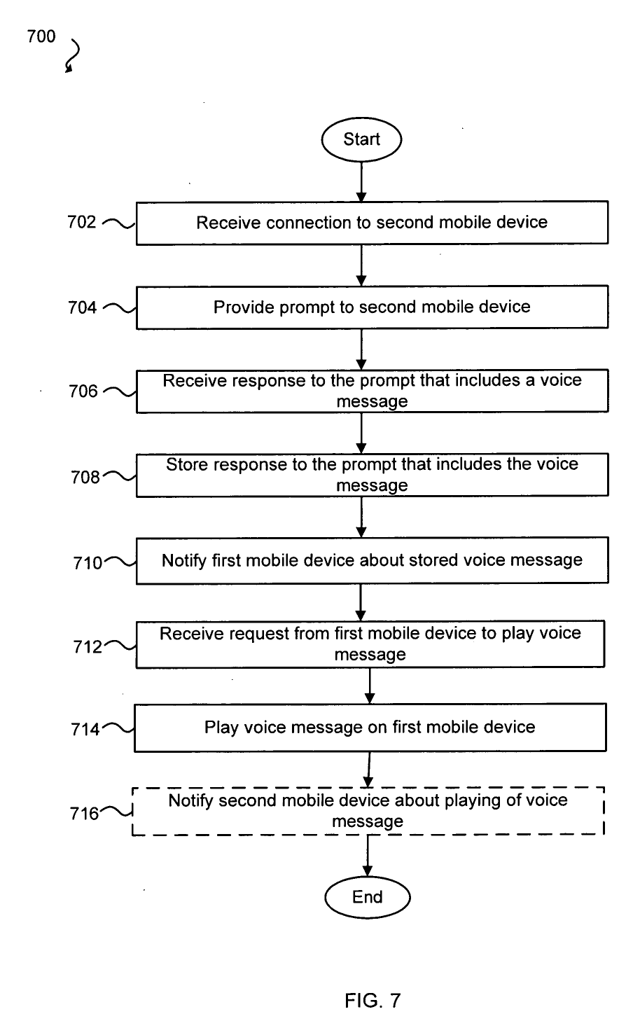

FIG. 7 is a flow chart of an exemplary method for distributing a voice message to a first mobile device wherein a telecommunication network diverts a connection from a second mobile device to a bubble server. The exemplary method 700 may be utilized in those cases where a recipient of a call lacks a way for a caller to leave a voice message. The exemplary method 700 provides a way for the caller to leave a voice message for the recipient.

At step 702, a bubble server receives a connection to a second mobile device belonging to a user (i.e. a caller) that is attempting to reach another user (i.e. a call recipient) associated with a first mobile device. In one exemplary embodiment, the received connection is diverted by a telecommunication network associated with the first mobile device. For example, when the caller places a call to the call recipient and receives no answer, a busy signal, out of service signal, voice mailbox is full signal, device is off signal, or the like, the telecommunication network associated with the first mobile device may divert the connection to the bubble server.

At step 704, a prompt is provided to the second mobile device from the bubble server. According to various exemplary embodiments, the prompt may comprise verbal instructions such as “to send this person a bubble message, please press 1.” After entry of the requested keystroke, a prompt may be provided that includes verbal instructions such as “please record after the tone.” Alternatively, after providing the prompt “to send this person a bubble message, please press 1” (and after entry of the requested keystroke), a prompt may be provided comprising a sound or other audio cue that indicates to the caller an appropriate time to record a voice message. In another embodiment, a prompt may comprise a sound that indicates to the caller an appropriate time to record a voice message. The prompt may also include information about a charge that will be billed to an account (e.g. an account with a telecommunication network or carrier) associated with the second mobile device in the event the caller decides to leave a voice message for the call recipient. In the event no response is left by the caller within a predefined time, the bubble server may communicate a message to the caller such as “goodbye” and terminate the connection.

At step 706, a response to the prompt is received by the bubble server. The response, according to several exemplary embodiments, may include a voice message from the second mobile device. The response may include other digital data (e.g. audio and/or visual data) in addition to or in place of the voice message.

At step 708, the response (e.g. voice message) is stored on the bubble server. Optionally, the second mobile device may be sent a notification by the bubble server about receipt and storage of the response by the bubble server.

At step 710, the first mobile device (i.e. the device associated with the call recipient) is notified by the bubble server about the stored message. In one exemplary embodiment, the notification may be sent via SMS to the first mobile device. Such a notification may include an indication of an identity of the caller and/or a link to the voice message. According to an alternative embodiment, the notification may be in the form of a call to the first mobile device.

At step 712, a request is received by the bubble server to play the voice message on the first mobile device. The request, according to various exemplary embodiments, is received from the first mobile device in response to the notification sent by the bubble server at step 710.

At step 714, the voice message is played on the first mobile device. According to one exemplary embodiment, the voice message is played on the first mobile device from the bubble server while the first mobile device is connected to the bubble server. According to an alternative embodiment, the voice message is sent to the first mobile device or to a telecommunication network associated with the first mobile device, from where the voice message may be played on the first mobile device with or without a connection to the bubble server.

At optional step 716, the bubble server may notify the second mobile device about the playing of the voice message on the first mobile device.

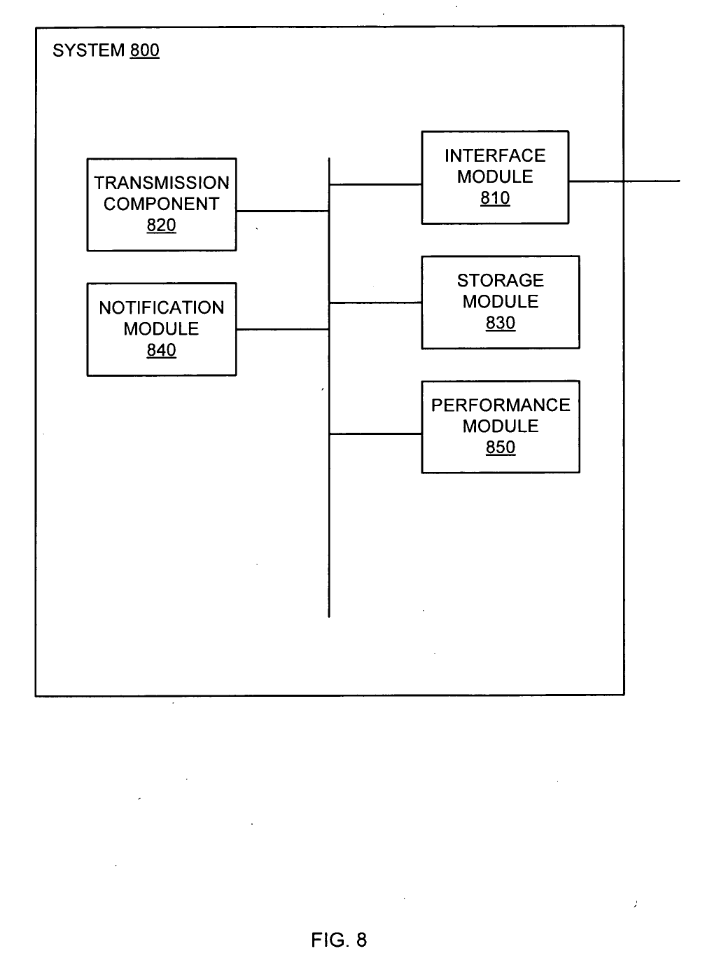

FIG. 8 is a partial block diagram of a system in an exemplary implementation for distributing a voice message to a first mobile device wherein a telecommunication network diverts a connection from a second mobile device to the system.

The system 800 may include a communications interface, a computer readable storage medium, and a processor. The computer readable storage medium may further comprise instructions for execution by the processor. The instructions for execution by the processor may cause the processor to play a voice message on a mobile device. Examples of computer readable storage medium may include discs, memory cards, servers and/or computer discs. Instructions may be retrieved and executed by a processor. Some examples of instructions include software, program code, and firmware. Instructions are generally operational when executed by the processor to direct the processor to operate in accord with embodiments of the invention. Although various modules may be configured to perform some or all of the various steps described herein, fewer or more modules may be provided and still fall within the scope of various embodiments. The processor may execute other instructions described herein and remain within the scope of contemplated embodiments.

As shown in FIG. 8, the exemplary system 800 comprises an interface module 810, a transmission component 820, a storage module 830, a notification module 840, and a performance module 850. According to one exemplary embodiment, the interface module 810 is configured to receive a connection to a second mobile device. The received connection is diverted to the interface module 810 by a telecommunication network associated with a first mobile device due to an occurrence of a predefined event. The transmission component 820 is configured to provide a prompt to the second mobile device and to receive a response to the prompt. According to various exemplary embodiments, the response includes the voice message from the second mobile device. The storage module 830 is configured to store the response received by the transmission component 820. The notification module 840 is configured to notify the first mobile device about the stored response and to receive a request to play the response on the first mobile device. The performance module 850 is configured to play the response on the first mobile device while connected to the system.

The embodiments discussed herein are illustrative of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A method for causing a voice message to play on a first mobile device, the method comprising:
receiving on a bubble server a connection to a second mobile device, the received connection diverted to the bubble server by a telecommunication network associated with the first mobile device due to an occurrence of a predefined event;
providing a prompt to the second mobile device from the bubble server;
receiving on the bubble server a response to the prompt, the response including the voice message from the second mobile device;
storing the voice message on the bubble server;
notifying the first mobile device by the bubble server about the stored voice message;
receiving by the bubble server a request to play the voice message on the first mobile device, the request received from the first mobile device in response to the notification; and
playing the voice message on the first mobile device while connected to the bubble server.

2. The method of claim 1, wherein the response to the prompt further includes entry of one button on a keypad of the second mobile device.

3. The method of claim 1, the method further comprising:
transacting a fee to an account associated with the second mobile device.

4. The method of claim 1, wherein the predefined event is no answer from the first mobile device.

5. The method of claim 1, wherein the predefined event is a busy signal from the first mobile device.

6. The method of claim 1, wherein the predefined event is a signal that a voice mailbox associated with the first mobile device is no longer accepting messages.

7. The method of claim 1, wherein the predefined event is a signal that the first mobile device is turned off.

8. The method of claim 1, wherein the predefined event is a signal that an owner associated with the first mobile device is not available.

9. The method of claim 1, wherein the predefined event is a signal indicating that the first mobile device is out of service.

10. The method of claim 1, wherein the prompt provided to the second mobile device includes instructions for a user of the second mobile device to enter a button on a keypad of the second mobile device.

11. The method of claim 1, the method further comprising:
notifying the second mobile device about receipt of the voice message by the bubble server.

12. The method of claim 1, the method further comprising:
notifying the second mobile device about the playing of the voice message on the first mobile device.

13. The method of claim 1, wherein the notifying the first mobile device about the stored voice message includes calling the first mobile device.

14. The method of claim 1, wherein the notifying the first mobile device about the stored message includes sending via SMS an indication of an identity of a caller associated with the second mobile device.

15. The method of claim 1, wherein the notifying the first mobile device about the stored message includes sending via SMS a link to the stored voice message.

16. A system for causing a voice message to play on a first mobile device, the system comprising:
a processor;
a computer readable storage medium having instructions for execution by the processor which causes the processor to play the voice message on the first mobile device;
wherein the processor is connected to the computer readable storage medium, the processor executing the instructions on the computer readable storage medium to:
receive a connection to a second mobile device, the received connection diverted to the system by a telecommunication network associated with the first mobile device due to an occurrence of a predefined event;
provide a prompt to the second mobile device;
receive a response to the prompt, the response including the voice message from the second mobile device;
store the voice message;
notify the first mobile device about the stored voice message;
receive a request to play the voice message on the first mobile device, the request received from the first mobile device in response to the notification; and
play the voice message on the first mobile device while connected to the system.

17. The system of claim 1, wherein the response to the prompt further includes entry of one button on a keypad of the second mobile device.

18. The system of claim 1, the method further comprising transacting a fee to an account associated with the second mobile device.

19. The system of claim 1, wherein the predefined event is no answer from the first mobile device.

20. A computer readable storage medium having embodied thereon a program, the program being executable by a computing device for performing a method comprising:
receiving on a bubble server a connection to a second mobile device, the received connection diverted to the bubble server by a telecommunication network associated with the first mobile device due to an occurrence of a predefined event;
providing a prompt to the second mobile device from the bubble server;
receiving on the bubble server a response to the prompt, the response including the voice message from the second mobile device;
storing the voice message on the bubble server;
notifying the first mobile device from the bubble server about the stored voice message;
receiving by the bubble server a request to play the voice message on the first mobile device, the request received from the first mobile device in response to the notification; and
playing the voice message on the first mobile device while connected to the bubble server.
